(19) United States
(12) Patent Application Publication
(10) Pub. No.: US 2019/0315010 A1
(43) Pub. Date: Oct. 17, 2019

(54) ROTATIONALLY ACTUATABLE BLADE, PARTICULARLY FOR AUTOMATIC INDUSTRIAL SLICING MACHINES

(71) Applicant: SLAYER BLADES S.R.L., Oggiona Con Santo Stefano (IT)

(72) Inventor: Gaetano SCATTOLIN, Oggiona Con Santo Stefano (IT)

(73) Assignee: SLAYER BLADES S.R.L., Oggiona Con Santo Stefano (IT)

(21) Appl. No.: 15/772,589

(22) PCT Filed: Jun. 13, 2016
(86) PCT No.: PCT/EP2016/063531

§ 371 Date: May 1, 2018

(30) Foreign Application Priority Data
Mar. 11, 2015 (IT) 102015000068182

(51) Int. Cl. B26D 1/00

(52) U.S. Cl. CPC B26D 1/0006; B26D 2001/0046; B26D 2001/002; B26D 2210/02; B26D 2001/006

(57) ABSTRACT

A rotationally actuatable blade, particularly for automatic industrial slicing machines, the blade comprising a blade body which extends around a main axis and has a central region for fixing a spindle for actuating the blade with a rotary motion about the main axis and a perimetric region which ends toward the outside with a sharp edge, the transition region, comprised between the central region and the perimetric region, having a plurality of concentric circumferential bends which follow each other with alternating bending directions and with extensions, parallel to the main axis, which decrease from the central region in the direction of the perimetric region.

The present invention relates to a rotationally actuatable blade, particularly for automatic industrial slicing machines. More specifically, the blade in question is intended to be used for cutting in sequence portions of food products such as hams, stuffed-meat products, cheeses and the like.

Automatic industrial slicing machines are known which are capable of carrying out the cutting in sequence of food products. Such machines can reach high rates of productivity thanks to the use of rotating blades which are actuated with very high rotation speeds.

For this reason, the blades to be used on these types of machines must have high strength and rigidity so as to ensure an adequate lifetime and a constant thickness of the cut products.

Currently, the blades used on these types of machines are shaped like a disk or a sickle and are made of high-strength steel.

The demand for automatic slicing machines that are capable of reaching ever-higher productivity rates and therefore increasingly faster blade rotation speeds, as well as the need to extend the range of products that can be sliced, induces makers to constantly seek out solutions in order to offer blades with ever-increasing strength and rigidity.

The aim of the present invention is in fact to provide a blade of the rotationally actuatable type, particularly for automatic industrial slicing machines, which can ensure a strength and rigidity that are appreciably higher than those of rotating blades currently on the market.

Within this aim, an object of the invention is to provide a blade that is capable of reducing the vibrations and bending moments of the cutting edge of the blade so as to ensure high levels of precision and regularity in the thickness of the slices of cut product.

Another object of the invention is to provide a blade that offers the highest guarantees of safety and reliability in use.

Another object of the invention is to provide a blade that can be produced at low cost.

This aim and these and other objects which will become better apparent hereinafter are achieved by a rotationally actuatable blade, comprising a blade body which extends around a main axis and has a central region for fixing a spindle for actuating the blade with a rotary motion about said main axis and a perimetric region which ends toward the outside with a sharp edge, characterized in that the transition region, comprised between said central region and said perimetric region, has a plurality of concentric circumferential bends which follow each other with alternating bending directions and with extensions, parallel to said main axis, which decrease from said central region in the direction of said perimetric region.

Further characteristics and advantages of the invention will become better apparent from the description of a preferred, but not exclusive, embodiment of the blade according to the invention, which is illustrated by way of non-limiting example in the accompanying drawings wherein:

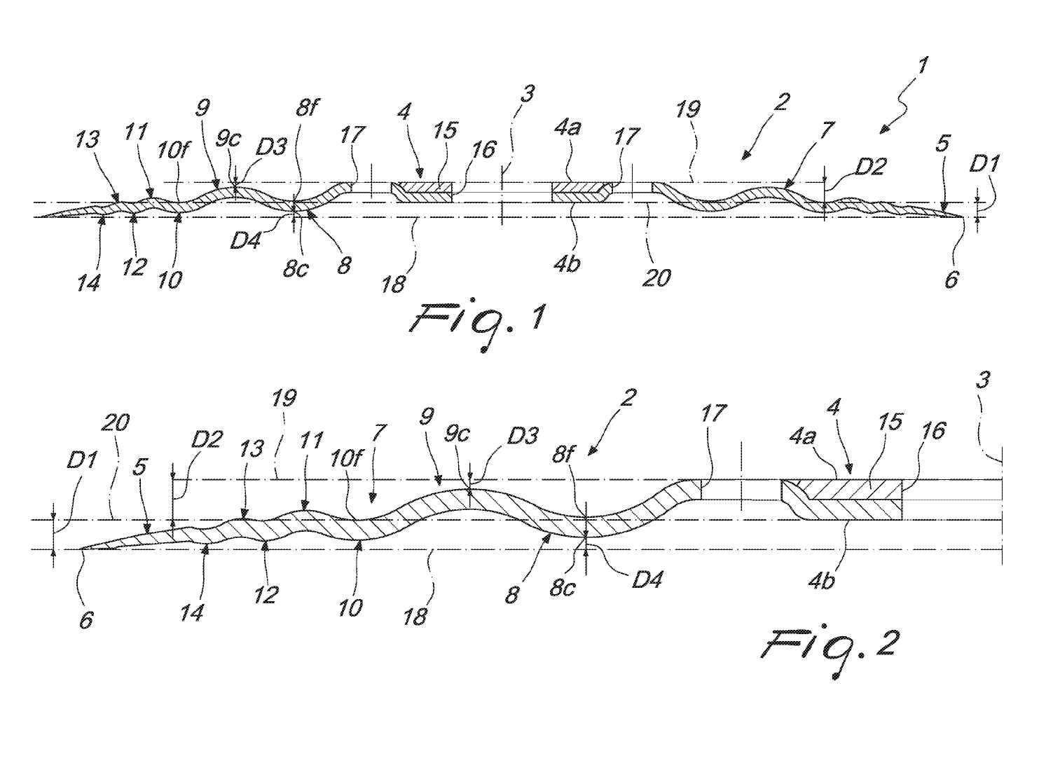

FIG. 1 is a schematic axial cross-section of a blade according to the invention;

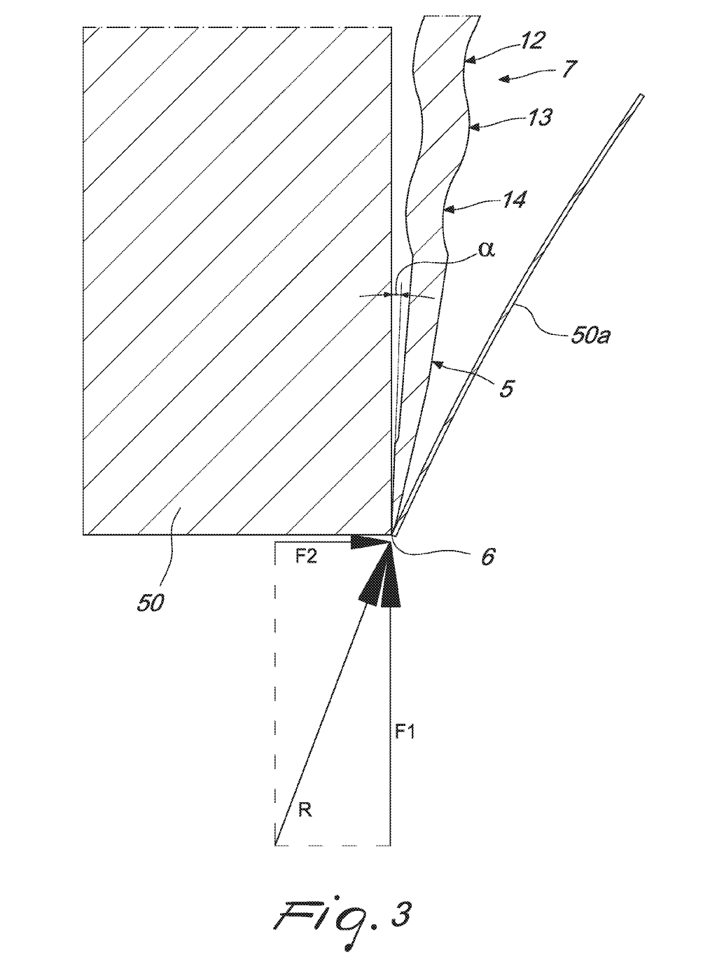

FIG. 2 is an enlarged detail of FIG. 1;

FIG. 3 is a further enlarged detail of FIG. 1 during the cutting of a product.

With reference to the figures, the blade according to the invention, generally designated by the reference numeral 1, comprises a blade body 2 which extends about a main axis 3 and has a central region 4 for fixing a spindle, conventional and not shown for the sake of simplicity, which can be actuated in order to impart a rotation about the main axis 3 to the blade.

The blade body 2 has a perimetric region 5 which ends toward the outside with a sharp edge 6.

According to the invention, the transition region 7, comprised between the central region 4 and the perimetric region 5, has a plurality of concentric circumferential bends, designated with the reference numerals from 8 to 14, which follow each other with alternating bending directions and with extensions, in a direction parallel to the main axis 3, which decrease from the central region 4 in the direction of the perimetric region 5.

The body of the blade 2 can be made, in a way that is known per se, of high strength steel.

The perimetric region 5 can be put on, and that is to say made of a different material from the remaining part of the blade body 2 and applied thereto by way of conventional techniques.

Preferably, the central region 4 has a greater thickness than the transition region 7. Such greater thickness for the central region 4 can be obtained by coaxially applying, for example by way of welding, a reinforcement disk 15, at such central region 4, to the remaining part of the blade body 2.

The central region 4 is passed through axially by a central hole 16 and by holes 17 arranged about the central hole 16.

Preferably, the bends 8-14 are provided in a wave-like manner, are mutually blended and have breadths that decrease progressively from the central region 4 to the perimetric region 5.

The function of the plurality of bends 8-14, which cover the transition region 7 and have breadths that decrease in the direction of the perimetric region 5, is to increase the rigidity of the blade during cutting and to reduce its vibrations. In practice the bends 8-14 constitute ridges for stiffening the transition region 7.

Advantageously, the bend 14 that is closest to the sharp edge 6 has a convexity that is directed in the opposite direction with respect to the deformation of the sharp edge 6 during the operation to cut a product 50.

More specifically, with reference to FIG. 3, the function of the bend 14, which is adjacent to the perimetric region 5 of the body of the blade 2, is to oppose the bending of the perimetric region 5 caused by the resultant R of the forces F1 and F2 which act on the perimetric region 5 during the cutting of a product 50.

Conveniently, the sharp edge 6 lies on a lower plane 18 which is perpendicular to the main axis 3 and delimits axially the body of the blade 2 on one side.

Preferably, the upper face 4a of the central region 4, which is the opposite face with respect to the face that can be fixed to the spindle or lower face 4b, lies on an upper plane 19, which is perpendicular to the main axis 3 and delimits axially the body of the blade 2 on the opposite side with respect to the lower plane 18.

Advantageously, the lower face 4b of the central region 4 lies on a spindle plane 20 which is parallel to the upper plane 19 and to the lower plane 18 and is arranged between these two planes 18 and 19. The distance D1 between the spindle plane 20 and the lower plane 18 is preferably less than the distance D2 between the spindle plane 20 and the upper plane 19.

Preferably, the first bend 8, starting from the central region 4, has a concavity that is directed toward the upper plane 19.

The distance D3 between the crest 9c of the first bend 9, starting from the central region 4, instead has a concavity directed toward the lower plane 18, and the upper plane 19 is preferably less than the thickness of the body of the blade 2 in the transition region 7.

Furthermore, the distance D4 between the crest 8c of the first bend 8, starting from the central region 4, has a concavity directed toward the upper plane 19, and the lower plane 18 is less than the thickness of the body of the blade 2 in the transition region 7.

The bottom 8f and 10f of the first two bends 8 and 10, starting from the central region 4, which have their concavity directed toward the upper plane 19, are preferably substantially tangent to the spindle plane 20.

Preferably, the blade body 2 has a disk-like shape and the sharp edge 6 extends along a circumference that is centered on the main axis 3.

The perimetric region 5, proximate to the sharp edge 6, forms, together with the lower plane 18, an acute angle α.

The blade according to the invention is preferably made of steel for use with food products.

Thanks to its particular geometry, the blade according to the invention is more rigid, as far as the cutting bending is concerned, by approximately 30% with respect to conventional disc-shaped blades.

The increased thickness of the central region 4, obtained preferably by way of welding a reinforcement disk 15, and also the particular shape structure of the wave-like bends 8-14 with breadths that decrease from the central region 4 toward the perimetric region 5 and which cover the transition region 7, both contribute to the greater rigidity of the blade.

Furthermore, this particular shape structure, with wave-like bends 8-14, appreciably reduces the vibrations of the blade and the bending of the perimetric region 5, thus achieving greater uniformity of the thickness of the cut slices 50a of the product 50. In particular, the presence of the bend 14 adjacent to the perimetric region 5 effectively opposes the bending of the perimetric region 5 during cutting.

In practice it has been found that the blade according to the invention fully achieves the set aim in that, thanks to its particular shape structure, it ensures a bending rigidity and a reduction of the vibrations during cutting which are considerably higher than in conventional blades, thus ensuring a long lifetime and a high uniformity of the thickness of cut of the product.

The blade, thus conceived, is susceptible of numerous modifications and variations, all of which are within the scope of the appended claims. Moreover, all the details may be substituted by other, technically equivalent elements.

In practice the materials employed, provided they are compatible with the specific use, and the dimensions, may be any according to requirements and to the state of the art.

The disclosures in Italian Patent Application No. 102015000068182 (UB2015A004834) from which this application claims priority are incorporated herein by reference.

1-13. (canceled)

14. A rotationally actuatable blade, comprising a blade body which extends around a main axis and has a central region for fixing a spindle for actuating the blade with a rotary motion about said main axis and a perimetric region which ends toward the outside with a sharp edge, wherein the transition region, comprised between said central region and said perimetric region, has a plurality of concentric circumferential bends which follow each other with alternating bending directions and with extensions, parallel to said main axis, which decrease from said central region in the direction of said perimetric region.

15. The blade according to claim 14, wherein said central region has a greater thickness than said transition region.

16. The blade according to claim 14, wherein said concentric circumferential bends are provided in a wave-like manner, are mutually blended and have breadths that decrease progressively from said central region to said perimetric region.

17. The blade according to claim 14, wherein a concentric circumferential bend of said plurality of concentric circumferential bends that is closest to said sharp edge has a convexity that is directed in the opposite direction with respect to the deformation of the sharp edge and which is induced by the product that is subjected to cutting during the cutting operation.

18. The blade according to claim 14, wherein said sharp edge lies on a lower plane which is perpendicular to said main axis and delimits axially the blade body on one side.

19. The blade according to claim 14, wherein an upper face of said central region,
which lies opposite with respect to a face that can be fixed to a spindle or lower face, lies on an upper plane, which is perpendicular to said main axis and delimits axially the blade body on the opposite side with respect to said lower plane.

20. The blade according to claim 19, wherein said lower face of said central region lies on a plane of the spindle that is parallel to said upper plane and to said lower plane, a distance between a plane of the spindle and said lower plane being less than a distance between said plane of the spindle and said upper plane.

21. The blade according to claim 19, wherein a first bend of said plurality of bends, starting from said central region, has a concavity that is directed toward said upper plane.

22. The blade according to claim 19, wherein a distance between a crest of a first bend of said plurality of bends, starting from said central region, which has its concavity directed toward said lower plane, and said upper plane is less than a thickness of said blade body in said transition region.

23. The blade according to claim 19, wherein a distance between a crest of a first bend of said plurality of bends, starting from said central region, which has its concavity directed toward said upper plane, and said lower plane is less than a thickness of said blade body in said transition region.

24. The blade according to claim 19, wherein a bottom of the first two bends of said plurality of bends, starting from said central region, which have their concavity directed toward said upper plane, are substantially tangent to said plane of the spindle.

25. The blade according to claim 14, wherein said blade body has a disk-like shape with said sharp edge extending along a circumference that is centered on said main axis.

26. The blade according to claim 18, wherein said perimetric region, proximate to said sharp edge, forms, together with said lower plane, an acute angle.
